(19) United States
(12) Patent Application Publication
(10) Pub. No.: US 2006/0081729 A1
(43) Pub. Date: Apr. 20, 2006

(54) Electrostatic spraying apparatus

(76) Inventor: Kimiyoshi Nagai, Yokohama-shi (JP)

Correspondence Address: KILYK & BOWERSOX, P.L.L.C., 400 HOLIDAY COURT, SUITE 102, WARRENTON, VA, 20186, US

(21) Appl. No.: 11/244,827

(22) Filed: Oct. 6, 2005

(30) Foreign Application Priority Data
Oct. 14, 2004 (JP) 2004-299925

(51) Int. Cl. B05B 5/00

(52) U.S. Cl. 239/690.1; 239/690; 239/703

(57) ABSTRACT

To prevent contamination by abnormal discharge in direct-charging electrostatic atomizers, a new electrostatic atomizer uses a main external electrode (13) and an auxiliary external electrode (17) located radially outward of an atomizer main body (4). A high-voltage supply line (15) for supplying a high voltage to the main external electrode (13) is connected to a head member (5) of the atomizer main body (4) by an additional conductor line (18), in which an auxiliary external electrode (17) is connected between a first and a second resistors (19, 20). When water paint is supplied to the rotary atomizing head (2) through a paint supply passage (10), the rotary atomizing head (2) is connected to the ground potential by the water paint itself, and automatically configured to operate as an indirect-charging electrostatic atomizer.

### FIELD OF THE INVENTION

This invention relates generally to an electrostatic spraying apparatus, and typically to an electrostatic atomizer having an external electrode. The invention contemplates applications for both conductive materials such as water paint and non-conductive materials such as oil paint, as well as applications for powder materials such as powder paint. Furthermore, the invention contemplates applications for spraying chemicals such as agrochemicals either in liquid or in powder.

### BACKGROUND OF THE INVENTION

Electrostatic spraying apparatuses have been widely used historically in the field of coating to adhere sprayed materials on works or other objects by electrostatic force. The technical field using electrostatic force has recently extended its territory to scattering or spreading of agrochemicals.

Electrostatic atomizers promulgated in the field of coating are roughly classified to direct-charging atomizers, configured to apply a high voltage to the main body of the atomizer, and indirect-charging atomizers, which include an external electrode outside the main body of the atomizer and apply a high voltage to the external electrode. Both these types of electrostatic atomizers are known to include bell type atomizers using a rotary member to expel the paint forward and gun type atomizers using a nozzle to expel the paint forward. As already known, electrostatic atomizers have expanded its range of applications to powder paints in addition to liquid paints. Japanese Patent Laid-open Publication No. JP-H10-43644 (equivalent to U.S. Pat. No. 5,922,131) discloses a gun-type electrostatic sprayer suitable for use with both liquid paints and powder paints. Japanese Patent Laid-open Publication No. JP-H11-505173 (equivalent to PCT International Publication No. WO 96/36438) discloses a bell-type atomizer suitable for use with powder paints.

Electrostatic atomizers of the direct charging type and those of the indirect charging type have been used with particular paint materials, respectively. A typical electrostatic atomizer of the direct charging type is disclosed in Japanese Laid-open Publication No. JP-H6-269701 (equivalent to U.S. Pat. No. 5,433,387). This is a bell-type atomizer, in which an electric field is generated in a region between the atomizer main body and a work by applying a high voltage to the main body (typically, a rotary atomizing head) to charge the paint expelled from the rotary atomizing head. Electrostatic atomizers of this type are used with non-conductive paints such as oil paints.

On the other hand, a typical electrostatic atomizer of the indirect charging type is disclosed in Japanese Laid-open Publication No. JP-H6-134352. This is a bell-type atomizer having a rotary atomizing head, in which an electric field is generated in a region between an external electrode located radially outward of the atomizer main body and a work by applying a high voltage to the external electrode to charge paint particles expelled from the rotary atomizing head and entering into the electric field. Electrostatic atomizers of this type are used with conductive materials such as oil paints containing metal powder, water paints, etc.

Bell-type electrostatic atomizers of the direct charging type are configured to discharge air forward from around the rotary atomizing head to urge paint particles first running radially outwardly from the rotary atomizing head back into the region of the electric field. However, if the air is not well-conditioned in pressure, quantity and velocity, paint particles rebound from the work and contaminate the surroundings.

On the other hand, electrostatic atomizers of the indirect charging type are subject to abnormal discharge (typically, streamer discharge) due to the existence of the insulating air layer between the atomizer main body and the external electrode. Abnormal discharge invites electric filed breakdown, which in turn decreases the paint deposition efficiency and contaminate the surroundings so much.

Electrostatic atomizers of the indirect charging type have another problem pointed out by Japanese Laid-open Publication No. JP-H6-320065. That is, because of a large potential difference between the external electrode and the atomizer main body, paint particles expelled from the paint sprayer become positively charged due to dielectric polarization, and contaminate the surroundings. To solve the problem of contamination, most electrostatic atomizers are enveloped by plastic members with high electric constants, such as fluorocarbon resin materials. To solve the same problem, the publication No. JP-H6-320065, however, proposes the use of an auxiliary external electrode interposed between the rotary atomizing head and the external electrode and connected to the ground potential to prevent concentration of the electric field to the circumferential edge of the rotary atomizing head.

Japanese Patent Laid-open Publication No. JP-H6-7709 deals with the problem of contamination as well, and proposes to use an auxiliary external electrode outside the main external electrode and apply to the auxiliary external electrode a voltage higher than that applied to the main external electrode. Since the auxiliary external electrode applied with the higher voltage enhances the electric field intensity between the atomizer and the work, this scheme has the merits of facilitating paint particles expelled from the paint releasing means to adhere onto the work and thereby reducing the problem of contamination so much.

The current stream of the coating industry is oriented toward substitution from traditional oil paints to water paints, taking the environmental problem into account. However, the substitution is still incomplete, and oil paints are still used as well. Under the circumstances, Japanese Laid-open publication No. JP-H9-192543 discloses an indirect-charging electrostatic atomizer for common use with water paints and oil paints. This dual-purpose atomizer includes a first high-voltage supply line for supplying a high voltage to the atomizer main body and a second high-voltage supply line for supplying a high voltage to an external electrode. When used with non-conductive paint (oil paint), the atomizer applies a high voltage to the main body through the first high-voltage supply line. When used with conductive paint (water paint), the atomizer applies a high voltage to the external electrode through the second high-voltage supply line.

The principle of electrostatic atomizers is now used in agrochemical spraying apparatuses as well (Japanese Patent Laid-open Publication No. JP-H8-275709) to make liquid or powder agrochemicals adhere onto agricultural goods with the aid of electrostatic force.

The invention is based on those problems and demands concerning conventional electrostatic atomizers and peripheral technologies to provide an electrostatic spraying apparatus, which is usable with paints or agrochemicals either conductive or non-conductive electrically, which can deposit a sprayed material onto intended objects more efficiently and less contaminates the surroundings accordingly, and which can alleviate contamination either by abnormal discharge pointed out in conjunction with conventional indirect-charging electrostatic atomizers or by dielectric polarization pointed out in conjunction with conventional direct-charging electrostatic atomizers.

### SUMMARY OF THE INVENTION

These problems are solved by the features summarized below.

According to the first aspect of the present invention, there is provided an electrostatic spraying apparatus comprising:

an apparatus main body (102) including a material releasing means (100) for expelling a material to be sprayed;

a material supply passage (106) for supplying the material from a material source (104) to the material releasing means (100), said material supply passage (106) being connected to a ground potential and in electrical connection with the apparatus main body (100);

an external electrode (108) located radially outward of the apparatus main body (102);

a high-voltage supply line (110) for supplying a high voltage to the external electrode (108); and

an additional conductor line (114) which connects the high-voltage supply line (110) to the apparatus main body (102) via a resistor (112).

Operation of the electrostatic spraying apparatus is explained with reference to FIG. 1 that shows a typical bell-type electrostatic atomizer. This bell-type electrostatic atomizer includes a rotary atomizing head, often called a bell cup, and the circumferential edge of the rotary atomizing head functions as an electrode. In case the bell-type electrostatic atomizer of FIG. 1 is used with a conductive paint such as water paint, the water paint flowing through the material supply passage (paint supply passage) 106 substantially connects the material releasing means (rotary atomizing head) 100 to the ground potential. On the other hand, in case the resistance value of the resistor 112 in the additional conductor line 114 is high enough to minimize the current flowing in the additional conductor line 114, even when the high-voltage supply line 110 is electrically connected to the apparatus main body 102 via the additional conductor line 114, the high voltage value applied to the external electrode 108 does not vary substantially. For example, if the resistance value of the resistor 112 in the additional conductor line 114 is 2 giga-Ω, and the high voltage of −100 kV is applied to the external electrode 108 through the high-voltage supply line 114, then the current that flows into the atomizer main body 114 through the additional conductor line 114 is as small as a current value in the order of μA, and the external electrode 108 can be applied with −100 kV substantially.

Therefore, when used with a conductive paint, the electrostatic atomizer is automatically configured to operate in substantially the same manner as conventional direct-charging electrostatic atomizers. In addition, the electrostatic spraying apparatus (electrostatic atomizer) is freed from the problem of abnormal discharge such as streamer discharge because the apparatus main body (atomizer main body) 102 is electrically connected to the external electrode 108 via the additional conductor line 114 and the apparatus main body (atomizer main body) 102 is connected to the ground potential by the conductive paint (water paint) flowing in the material supply passage (paint supply passage) 106 and serving as a conductor. Therefore, this apparatus overcomes deterioration of the deposition efficiency and contamination of the surroundings caused by abnormal discharge, which have been remarked as problems of conventional indirect-charging electrostatic atomizers.

The electrostatic spraying apparatus according to the first aspect of the invention can be used with non-conductive materials such as oil paints. Referring again to FIG. 1, in case an oil paint is charged in the material source (paint source) 104 and expelled from the material releasing means (rotary atomizing head) 100 via the material supply passage (paint supply passage) 106, the paint releasing means (rotary atomizing head) 100 and the apparatus main body (atomizer main body) 102 is electrically disconnected from the ground potential by the oil paint flowing through the material supply passage (paint supply passage) 106 and serving as an insulator. Thus, the apparatus main body 102 (atomizer main body) 102 is applied with the high voltage through the additional conductor line 114, and the atomizer is automatically configured to operate equivalently to conventional direct-charging electrostatic atomizers.

In addition, when the apparatus is used with an oil paint, the external electrode 108, which is located radially outward of the apparatus main body (atomizer main body) 102 and applied with a high voltage through the high-voltage supply line 110, generates an additional electric field. Therefore, even though part of paint particles expelled from the paint releasing means 100 deviates radially outwardly from the direct-charging region generated between the apparatus main body 102 and the work W, those paint particles are charged by the additional electric field outside the direct-charging region, and do not contaminate the surroundings.

The bell-type electrostatic atomizer shown in FIG. 1 may include a second external electrode 116 different in distance D from the apparatus main body 102 as shown in FIG. 2. In greater detail, if the distance D between the first external electrode 108 and the internal electrode, i.e. the circumferential edge of the material releasing means (rotary atomizing head) 100, is D1, then the distance D2 between the second external electrode 116 and the circumferential edge of the material releasing means (rotary atomizing head) 100 is larger or smaller than the distance D1 (in the illustrated example, D2<D1). The second external electrode 116 is applied with a high voltage through a second high-voltage supply line 118, which is connected to the apparatus main body 102 (atomizer main body) 102 via a second resistor 120 with a high resistance value. In the case of D2<D1, voltage V2 to the second external electrode 116 is adjusted lower than the voltage V1 to the first external electrode 108. In contrast, in case of D2>D1, the voltage V2 is adjusted higher than the voltage V1.

Also when the electrostatic spraying apparatus is a bell-type electrostatic atomizer shown in FIG. 2, it ensures the same functions and operations as those of the electrostatic spraying apparatus explained with reference to FIG. 1, and rather has some additional advantages. That is, by locating a plurality of external electrodes 108, 106 at different distances from the material releasing means 100 and applying a higher voltage to one of the electrodes remoter from the material releasing means 100 than that applied to the other electrode (V1>V2), in other words, by applying a lower voltage to the other external electrode nearer to the material releasing means 100, the apparatus having the configuration of FIG. 2 can locate the innermost electrode 116 closer to the material releasing means 100. Thereby, even though part of paint particles expelled from the material (paint) releasing means 100 is positively charged due to dielectric polarization, the apparatus can immediately re-charge these paint particles to negative ions by the electric field between the external electrode 116 nearest to the paint releasing means 100 and the apparatus (atomizer) main body 102. This is effective for alleviating contamination caused by dielectric electrostatic polarization.

According to the second aspect of the invention, as better understood from FIG. 3, there is provided an electrostatic spraying apparatus comprising:

an apparatus main body (102) including a material releasing means (100) for expelling a material to be sprayed;

a material supply passage (106) for supplying the material from a material source (104) to the material releasing means (100), said material supply passage (106) being connected to a ground potential and in electrical connection with the apparatus main body (102);

a main external electrode (108) located radially outward of the apparatus main body (102);

an auxiliary external electrode (124) located radially outward of the apparatus main body (102) more closely than the main external electrode (108);

a high-voltage supply line (110) for supplying a high voltage to the main external electrode (108);

a first conductor line (128) which connects the high-voltage supply line (108) to the auxiliary external electrode (124) via a first resistor (126); and

a second conductor line (132) which connects the auxiliary external electrode (124) to the apparatus main body (102) via a second resistor (130).

FIG. 3 shows a bell-type electrostatic atomizer as an example of electrostatic spraying apparatus according to the second aspect of the invention. This bell-type electrostatic atomizer has substantially the same functions and operations as those of the bell-type electrostatic atomizer shown in FIG. 2. That is, when used with a conductive paint such as water paint, the apparatus is automatically configured to function as an indirect-charging electrostatic atomizer. When used with a non-conductive paint such as oil paint, the apparatus is automatically configured to function as a direct-charging electrostatic atomizer. When the apparatus operates in the direct-charging mode, the main external electrode 108 and the auxiliary external electrode 124 are in electrical connection with the apparatus main body 102 through the first and second conductor lines 128, 132. Therefore, the apparatus can prevent abnormal discharge such as streamer discharge.

Alternatively, as shown in FIG. 4, the electrostatic spraying apparatus according to the second aspect of the invention may include auxiliary external electrodes 124, 132 different in distance D from the apparatus main body 102 from each other. In this case, a plurality of resistors 126, 130, 136 et al. are connected in series to each other to respectively appear between every two adjacent electrodes in an additional conductor line 134, connected between the high-voltage supply line 110 for supplying a high voltage to the main external electrode 108, and the apparatus main body 102. That is, in the additional conductor line 134, the first auxiliary external electrode 124 is connected between the first resistor 126 and the second resistor 130 and the second auxiliary external electrode is connected between the second resistor 130 and the third resistor 136.

This construction results in making a direct-charging electrostatic spraying apparatus having a plurality of external electrodes 108, 124, 132 different in distance radially outward of the apparatus main body 102. Thus, the voltage V3 to the second auxiliary external electrode nearest to the apparatus main body 102 becomes lowest, the voltage V2 to the first auxiliary external electrode 124 remoter from the apparatus main body 102 becomes higher than the voltage V3, and the voltage V1 to the main external electrode 108 remotest from the apparatus main body 102 becomes highest (V1>V2>V3). Here again, resistance values of the resistors 126, 130, 136 in each additional conductor line 134 may be determined to minimize the current flowing in the additional conductor line 114.

The electrostatic atomizer having the construction of FIG. 3 or FIG. 4 can prevent abnormal discharge similarly to or even better than the electrostatic atomizer having the construction of FIG. 1 or FIG. 2, and can be used with non-conductive materials such as oil paints as well. Further, the innermost auxiliary external electrode 132 prevents contamination caused by dielectric polarization.

### BRIEF DESCRIPTION OF THE DRAWINGS

FIG. 1 is a schematic diagram for explaining the basic concept of the first aspect of the invention;

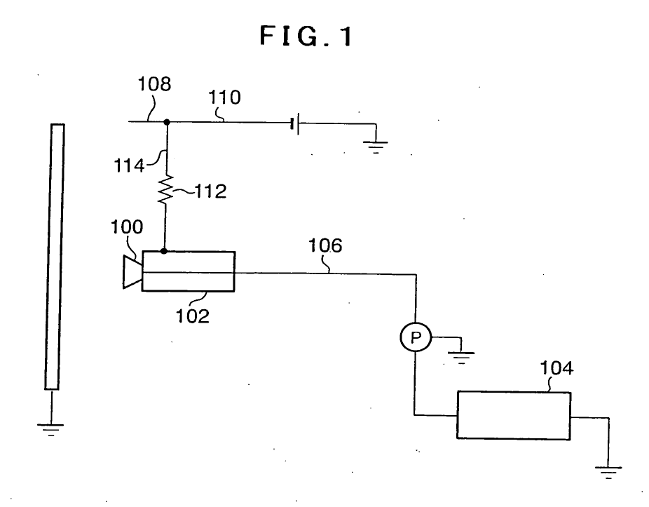

FIG. 2 is a diagram for explaining a modification of the basic concept shown in FIG. 1;

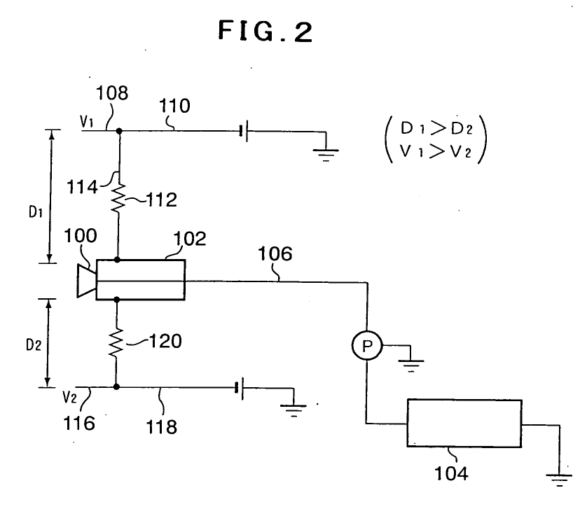

FIG. 3 is a schematic diagram for explaining the basic concept of the second aspect of the invention;

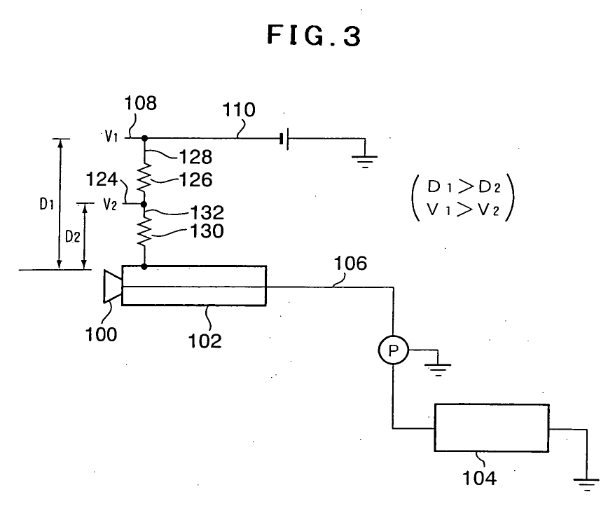

FIG. 4 is a diagram for explaining a modification of the basic concept shown in FIG. 3;

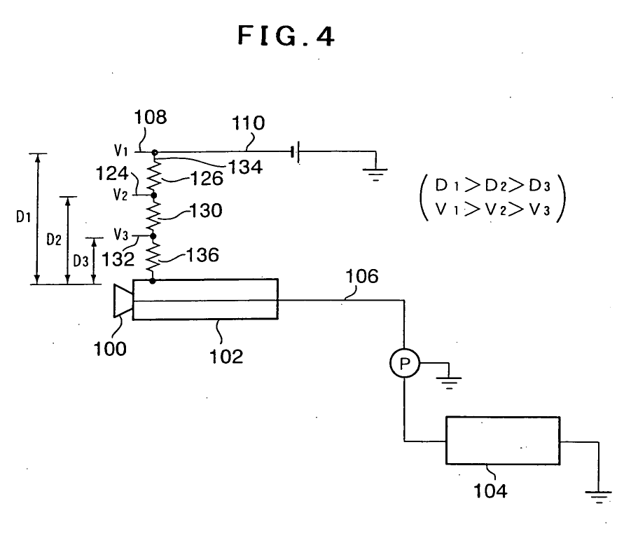

FIG. 5 is a diagram showing a general construction of a bell-type electrostatic atomizer according to an embodiment of the invention;

FIG. 6 is a diagram showing a layout of main external electrodes and auxiliary external electrodes in a bell-type atomizer;

FIG. 7 is a diagram showing another layout of main external electrodes and auxiliary external electrodes in a bell-type atomizer;

FIG. 8 is a diagram showing a layout of main external electrodes and auxiliary external electrodes in a gun-type atomizer;

FIG. 9 is a diagram showing another layout of main external electrodes and auxiliary external electrodes in a gun-type atomizer;

FIG. 10 is a diagram showing a general construction of a modified electrostatic atomizer;

FIG. 11 is a diagram showing a general construction of another modified electrostatic atomizer; and

FIG. 12 is a diagram showing a layout of external electrodes in a construction including multi-layered external electrodes different in distance from the rotary atomizing head to surround the rotary atomizing head in multiple layers.

### DETAILED DESCRIPTION OF THE INVENTION

Some embodiments will now be explained below with reference to the drawings.

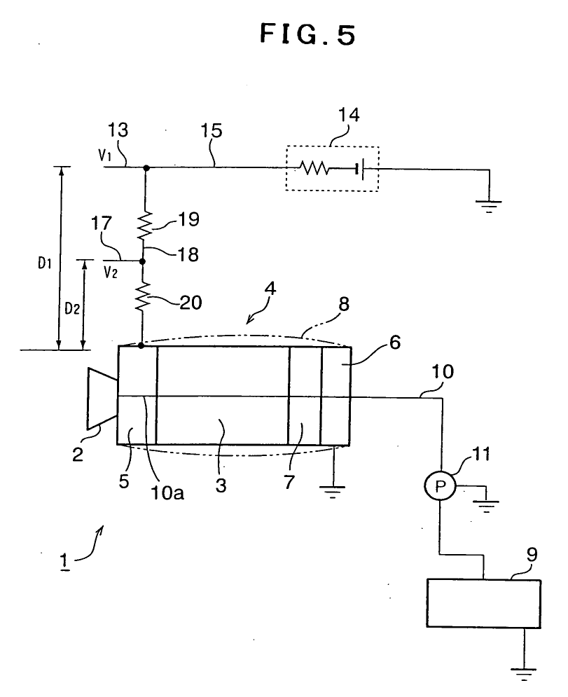

FIG. 5 shows an electrostatic atomizer according to an embodiment of the invention. The electrostatic atomizer 1 shown here is a so-called bell-type atomizer has a rotary atomizing head and configured to expel paint particles radially outwardly from the rotary atomizing head rotated at a high speed by an air motor 3.

The main body 4 of the bell-type electrostatic atomizer 1 has substantially the same construction as that of conventional atomizers. More specifically, the atomizer main body 4 has the rotary atomizing head 2 rotatably supported on a metal head member 5 and driven by the air motor. The atomizer main body 4 has a grounding plate 6 at the rear end thereof. An insulating layer 7 is preferably interposed between the grounding plate 6 and the air motor 3. The atomizer main body 4 is preferably covered by an insulating cover 8 like conventional atomizers.

The bell-type electrostatic atomizer 1 is typically mounted on an arm of a coating robot (not shown). The rotary atomizing head 2 is supplied with paint through a paint supply passage 10 communicating with a paint source 9. In other words, a downstream end of the paint supply passage 10 is continuous to a paint passage 10a inside the head member 5, which connects the paint supply passage 10 to a central part of the rotary atomizing head 2. The paint in the paint source 9 is pumped out to the atomizer main body 4 by a pump 11. The grounding plate 6, paint source 9 and pump 11 are connected to the ground potential.

The bell-type electrostatic atomizer 1 has a main external electrode 13 located radially outward of the atomizer main body 4. The main external electrode 13 is supplied with a high voltage from a high-voltage generator 14 through a high-voltage supply line 15. In addition, the electrostatic atomizer 1 has an auxiliary external electrode 17 that is located nearer to the atomizer main body 4 than the main external electrode 13. That is, distance D1 of the main external electrode 13 from the circumferential edge of the rotary atomizing head 2 is larger than the distance D2 of each auxiliary external-electrode 17 from the circumferential edge of the rotary atomizing head 2 (D1>D2).

The head member 5 is connected to a high-voltage supply line 15 by an additional conductor line 18. In the additional conductor line 18, a first and a second resistors 19, 20 are connected in series at opposite ends of the auxiliary external electrode 17. If the high voltage supplied to the main external electrode 13 from the high-voltage generator 14 is −100 kV, then the first and second resistors 19, 20 may have the resistance value of 1 giga Ω equally. However, resistance values of the first and second resistors 19, 20 may be determined otherwise, taking account of the distance D2 of the auxiliary external electrode 17 and the distance D1 of the main external electrode 13. For example, if the distance D2 of the auxiliary external electrode is one half the distance D1 of the main external electrode 13 (D2=(½)×D1), then the first and second resistors 19, 20 may be equal in resistance value (for example, 1 giga Ω, equally). If the distance D2 of the auxiliary external electrode 17 is one third the distance D1 of the main external electrode 13 (D2=(⅓)×D1), then the resistance values of the first and second resistors 19, 20 may be 2:1 in their relative ratio (for example, {2×(⅔)} giga Ω as the first resistor 19 and {2×(⅓)} giga Ω as the second resistor 20). The first and second resistors 19, 20 may be in form of discrete resistor devices or in form of a single resistor device.

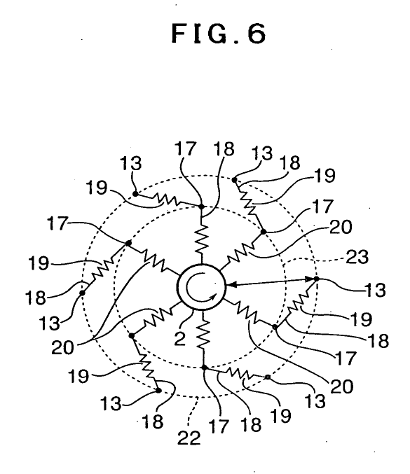

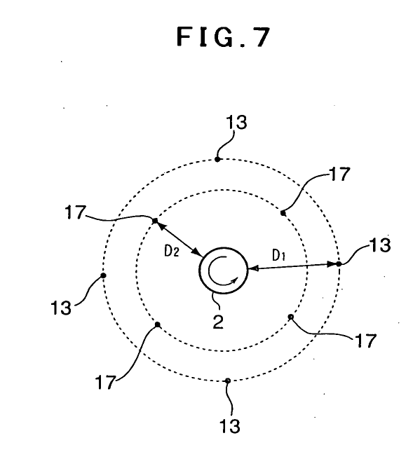

FIGS. 6 and 7 illustrate layouts of main external electrodes 13 and auxiliary external electrodes 17. In the layout of FIG. 6, six main external electrodes 13 are aligned in equal intervals along a circle concentrically encircling the rotary atomizing head 2 from the radial distance D1, and six auxiliary external electrodes 17 are aligned in equal intervals along a circle concentrically encircling the rotary atomizing head 2 from the radial distance D2. To supply a high voltage to the main external electrodes 13, all external electrodes 13 may be connected by a first ring-shaped conductor line 22, which supplies the high voltage to these electrodes 13 altogether from a single high-voltage supply line 15. Alternatively, each main external electrode 13 may be supplied with the high voltage through its own high-voltage supply line 15 individually.

Similarly, six auxiliary external electrodes 17 may be connected by a second ring-shaped conductor line 23 that is connected to the first ring-shaped conductor line 23 and the head member 5 by an additional conductor line 18, and the first and second resistors may be connected in the single additional conductor line 18. However, in the case where each main external electrode 13 is supplied with the high voltage through its own high-voltage supply line 15 individually, each auxiliary external electrode 17 may have its own additional conductor line 18 that connects the associated high-voltage supply line 15 to the head member 5. In this case, the first and second resistors 19, 20 may be connected in each additional conductor line 18.

FIG. 6 also shows that the main external electrodes 13 and the auxiliary external electrodes 17 are offset in the rotational direction such that each auxiliary external electrode 17 is equally distant from two nearest main external electrodes 13, 13.

In the layout shown in FIG. 7, four main external electrodes 13 are provided in equal intervals on a circle concentrically encircling the rotary atomizing head 2 from the radial distance D1, and four auxiliary external electrodes 17 are provided in equal intervals along a circle concentrically encircling the rotary atomizing head 2 from the radial distance D2. Here again, the main external electrodes 13 and the auxiliary external electrodes 17 are offset in the rotational direction such that each auxiliary electrode 17 is equally distant from two nearest main external electrodes 13, 13.

A skilled person in the art will understand that the layouts shown in FIGS. 6 and 7 are mere examples and that modified layouts are acceptable as well. For example, the number of main external electrodes 13 or the number of auxiliary external electrodes 17 may be determined as desired, and the main external electrodes 13 and/or the auxiliary external electrodes 17 may be unequally spaced from each other. In addition, it can be freely determined how and whether the auxiliary external electrodes 17 are offset from the main external electrodes 13. For example, both the main external electrodes 13 and the auxiliary external electrodes 17 may be aligned on common radial lines from the center of the rotary atomizing head 2.

As explained, FIGS. 6 and 7 show layouts suitable for bell-type electrostatic atomizers. However, if the electrostatic atomizer 1 shown in FIG. 5 is a gun-type atomizer having an injection nozzle such as air spray nozzle or hydraulic atomizing nozzle, the atomization pattern becomes elliptic depending upon the profile of the patterning air. In case of gun-type electrostatic atomizers, an atomizing nozzle is incorporated into the head member 5.

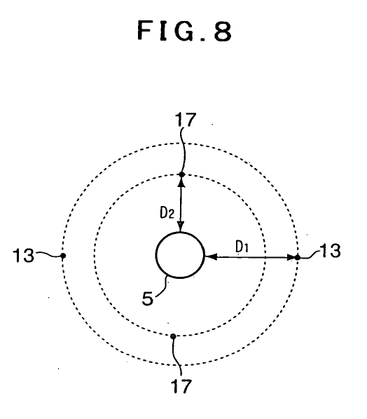

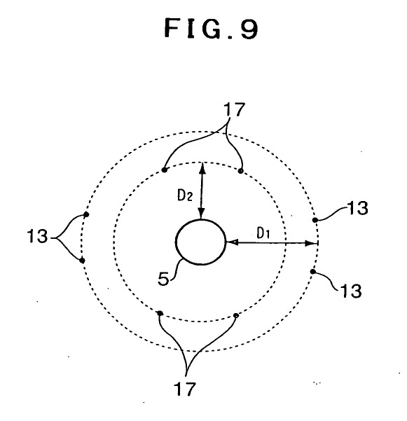

FIGS. 8 and 9 illustrate layouts of the main external electrodes 13 and the auxiliary external electrodes 17 suitable for gun-type atomizers. As shown in FIGS. 8 and 9, the main external electrodes 13 are diametrically opposed to each other in the horizontally direction on the drawing sheet, and the auxiliary external electrodes 17 are diametrically opposed to each other in the vertical direction on the drawing sheet suitably for an elliptic spray pattern.

Again referring to FIG. 5, when the bell-type electrostatic atomizer 1 having an external electrode 13 and 17 is used with a conductive paint such as water paint, its rotary atomizing head 2 is grounded by the water plaint supplied from the paint source 9. On the other hand, although the high-voltage supply line 15 connected to the main external electrode 13 is electrically connected to the rotary atomizing head 2 via the additional conductor line 18, the first and second resistors 19, 20 of a high resistance value are inserted in the additional conductor line 18, the current flowing in the additional conductor line 18 is very small. Therefore, the main external electrode 13 is applied with a voltage V1 that is substantially the same as the high voltage supplied from the high-voltage generator 14, and the auxiliary external electrode 17 is applied with a voltage V2 that is lower than the voltage V1 by the voltage drop caused by the resistor 19 connected between the auxiliary external electrode 17 and the high-voltage supply line 15.

Therefore, when used with water paint, the electrostatic atomizer shown in FIG. 5 is automatically configured to operate as an atomizer including double external electrodes 17, 13 aligned in the radial direction from the rotary atomizing head 2. In this case, the auxiliary external electrode 17 nearer to the rotary atomizing head 2 is applied with the lower voltage V2 whereas the main external electrode 13 remoter from the rotary atomizing head 2 is applied with the higher voltage V1.

As a result, in the same manner as conventional indirect-charging atomizers having external electrodes, the electrostatic atomizer 1 can electrically charge paint particles expelled from the rotary atomizing head and can accomplish electrostatic coating. In this case, however, since the auxiliary external electrode 17 and the main external electrode 13 doubly inserted in the radial direction are electrically connected to the conductive head member 5 by the additional conductor line 18, the electrostatic atomizer 1 can prevent abnormal discharge (streamer discharge) between the auxiliary external electrode 17 and the main external electrode 13. Therefore, the electrostatic atomizer 1 shown in FIG. 5 can overcome the problem of contamination of the surroundings and deterioration of the deposition efficiency caused by electric field breakdown derived from abnormal discharge, which has been a serious issue of conventional indirect-charging electrostatic atomizers. Furthermore, even though plus ions generate near the rotary atomizing head 2 due to dielectric polarization, the charging region generated between the auxiliary external electrode 17 and the rotary atomizing head 2, which are positioned relatively near, can re-charge these positive ions to minus ions. Therefore, the problem of contamination caused by dielectric polarization is alleviated.

The electrostatic atomizer 1 shown in FIG. 5 can be used for electrostatic coating of non-conductive paint such as oil paint. More specifically, if the paint source 9 contains oil paint, then the paint supply passage 10 is disconnected from the ground potential by the oil paint supplied from the paint source 9. On the other hand, the high-voltage supply line 15 connected to the main external electrode 13 is electrically connected to the rotary atomizing head 2 via the head member 5, made of a conductive material, and the additional conductor line 18. Therefore, the rotary atomizing head 2 is applied with a high voltage. Thus, when used with oil paint, the electrostatic atomizer 1 is automatically configured to operate in the same manner as conventional direct-charging electrostatic atomizers.

When used with oil paint, the electrostatic atomizer 1 shown in FIG. 5 demonstrates additional advantages not obtained by conventional direct-charging electrostatic atomizers. More specifically, when the electrostatic atomizer 1 is used with oil paint, an additional electric field is generated in the region between the external electrodes 13, 17 and the work outside the region of the main electric field between the rotary atomizing head 2 and the work. Therefore, if part of paint particles expelled from the rotary atomizing head 2 scatters radially outwardly and fails to enter the main electric field region, then the additional electric field region generated by the external electrodes 13, 17 electrically charges these paint particles and makes them electrically attracted onto the work. Therefore, when used with oil paint, the electrostatic atomizer 1 shown in FIG. 5 can alleviate the problem of contamination of the surroundings and can enhance the deposition efficiency accordingly, as compared with conventional direct-charging electrostatic atomizers.

As such, the electrostatic atomizer according to the foregoing embodiment is automatically prepared to operate in the indirect charging mode or in the direct charging mode, depending upon the paint used, without the use of a particular means such as a switch. In addition, when used for coating with conductive paint such as water paint, the electrostatic atomizer 1 according to the embodiment overcomes the main problems involved in the conventional indirect-charging atomizers. Moreover, when used for coating with non-conductive paint such as oil paint, this atomizer overcomes the main problems involved in the conventional direct-charging atomizers. If the electrostatic atomizer 1 is used exclusively with conductive paints such as water paint, the insulating layer 7 and/or the insulating cover 8 may be omitted from the atomizer main body 4.

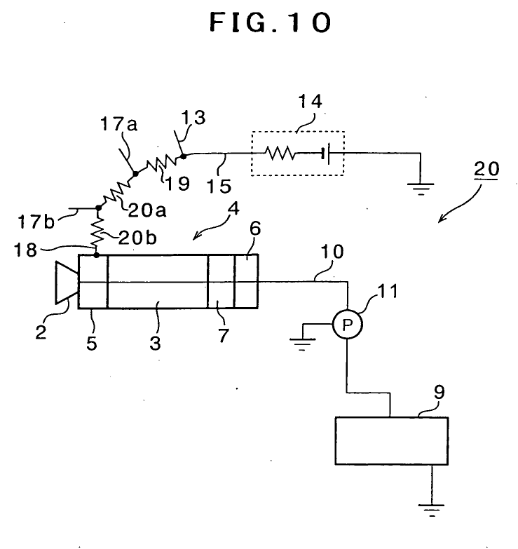

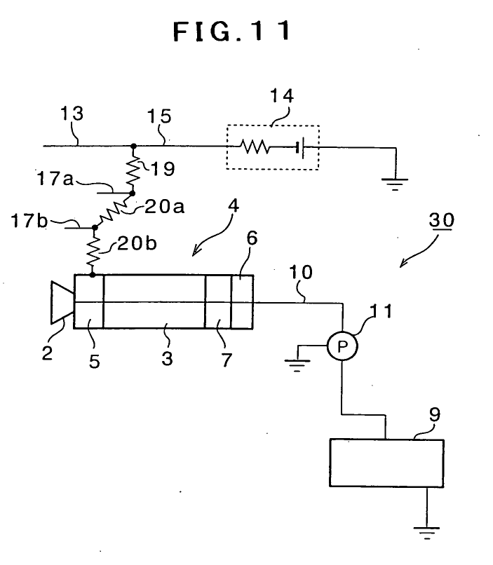

FIGS. 10 and 11 show modifications of the above-explained atomizer 1. In modified electrostatic atomizers 20, 30 shown in FIGS. 10 and 11, the tip of the main external electrode 13 is positioned behind the rotary atomizing head 2 to enhance the effect of preventing contamination. In addition, here are used a plurality of (two, in this case) auxiliary external electrodes 17a, 17b, . . . spaced apart in the radial direction from the rotary atomizing head 2 and from each other, and the tips of these electrodes 17a, 17b, . . . are gradually offset behind toward the main external electrode 13. This is effective for enhancing the effect of preventing contamination as well. Along with the increase of auxiliary external electrodes 17a, 17b, . . . , additional resistors 20a, 20b, . . . are connected as well.

More specifically, in the example of FIG. 10, the tip of one of the auxiliary external electrodes, 17b, nearest to the rotary atomizing head 2 is positioned on an imaginary straight line extending from the circumferential edge of the rotary atomizing head 2 approximately normally to the axial direction of the atomizer main body 4, and the tips of the other auxiliary external electrode 17a and the main external electrode 13 are positioned on an imaginary line continuous from the said straight line and declining toward the barrel of the atomizer main body 4. This layout of external electrodes prevents self-contamination of the atomizer main body 4 and a robot arm (not shown) because negatively charged paint particles existing outside the electrostatic atomizer 20 rebels against the electric fields generated by the auxiliary external electrode 17a and the main external electrode 13 during rotational, horizontal or vertical movements of the coating robot arm.

The same effect is obtained by the construction of the electrostatic atomizer 30 shown in FIG. 11 as well. More specifically, in the electrostatic atomizer 30 of FIG. 11, the tip of the main external electrode 13 is positioned on a line extending from the circumferential edge of the rotary atomizing head 2 approximately normally to the axial direction of the atomizer main body 4. Further, the auxiliary external electrodes 17a, 17b, . . . are aligned to be offset backward more and more as they are radially remoter from the rotary atomizing head 2.

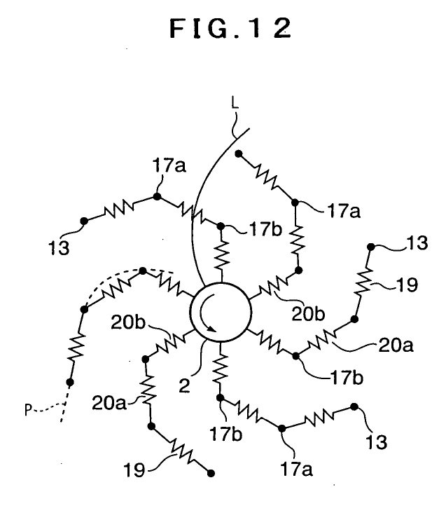

When a plurality of external electrodes 13, 17a, 17b, . . . are provided to multiply encircle the main body 4 of a bell-type electrostatic atomizer as shown in FIGS. 10 and 11, these external electrodes 13, 17a, 17b, . . . may be aligned in the order of the main external electrode 13 and auxiliary external electrodes 17a, 17b, . . . on a parabolic line P (electrode alignment parabolic line) extending in the rotating direction of the rotary atomizing head 2 (in the counterclockwise direction shown by an arrow). In operation of the electrostatic atomizer, threads of liquid or paint particles expelled from the rotary atomizing head 2 draw parabolic lines L (paint parabolic lines) oriented in the opposite direction from the rotating direction of the rotary atomizing head 2. However, the construction shown in FIG. 12, which orients the electrode alignment parabolic lines P toward the rotating direction of the rotary atomizing head 2, permits the paint drawing the paint parabolic lines L to sequentially enter into respective electric fields generated by the inner auxiliary external electrode 17b, outer auxiliary external electrode 17a and main external electrode 13 aligned on the electrode alignment parabolic lines P. This increases the chance of electrically charging the paint particles. Therefore, this construction can uniform electrical charging of paint particles expelled from the entire circumferential edge of the rotary atomizing head 2.

Heretofore, some embodiments have been explained in form of applications to electrostatic atomizers used with liquid paints. However, the invention is applicable to atomizers used with powder paints as well. Moreover, the principle of the invention is applicable widely to electrostatic spraying apparatuses for spraying powder or liquid such as agrochemicals to electrostatically deposit it onto a target object.

What is claimed is:

1. An electrostatic spraying apparatus comprising:
an apparatus main body including a material releasing means for expelling a material to be sprayed;
a material supply passage for supplying the material from a material source to the material releasing means, said material supply passage being connected to a ground potential and in electrical connection with the apparatus main body;
an external electrode located radially outward of the apparatus main body;
a high-voltage supply line for supplying a high voltage to the external electrode; and
an additional conductor line which connects the high-voltage supply line to the apparatus main body via a resistor.

2. An electrostatic spraying apparatus comprising:
an apparatus main body including a material releasing means for expelling a material to be sprayed;
a material supply passage for supplying the material from a material source to the material releasing means, said material supply passage being connected to a ground potential and in electrical connection with the apparatus main body;
a main external electrode located radially outward of the apparatus main body;
an auxiliary external electrode located radially outward of the apparatus main body more closely than the main external electrode;
a high-voltage supply line for supplying a high voltage to the main external electrode;
a first conductor line which connects the high-voltage supply line to the auxiliary external electrode via a first resistor; and
a second conductor line which connects the auxiliary external electrode to the apparatus main body via a second resistor.

3. The apparatus according to claim 2, which is operative as an electrostatic atomizer.

4. The apparatus according to claim 3 wherein the material to be sprayed is in form of liquid or powder.

5. The apparatus according to claim 2 wherein the auxiliary external electrode is located behind the material releasing means.

6. The apparatus according to claim 2 wherein the main external electrode is located behind the material releasing means.

7. An electrostatic spraying apparatus comprising:
An electrostatic spraying apparatus comprising:
an apparatus main body including a material releasing means for expelling a material to be sprayed;
a material supply passage for supplying the material from a material source to the material releasing means, said material supply passage being connected to a ground potential and in electrical connection with the apparatus main body;
a main external electrode located radially outward of the apparatus main body;
a first auxiliary external electrode located radially outward of the apparatus main body more closely than the main external electrode;
a second auxiliary external electrode located radially outward of the apparatus main body more closely than the first auxiliary external electrode;
a high-voltage supply line for supplying a high voltage to the main external electrode;
a first conductor line which connects the high-voltage supply line to the first auxiliary external electrode via a first resistor;
a second conductor line which connects the first auxiliary external electrode to the second auxiliary external electrode via a second resistor; and
a third conductor line which connects the second auxiliary external electrode to the apparatus main body via a third resistor.

8. An electrostatic spraying apparatus comprising:
an apparatus main body including a material releasing means for expelling a material to be sprayed;
a material supply passage for supplying the material from a material source to the material releasing means, said material supply passage being connected to a ground potential and in electrical connection with the apparatus main body;
a main external electrode positioned radially outward of the apparatus main body;
auxiliary external electrode means positioned radially outward of the apparatus main body more closely than the main external electrode;
an additional conductor line which connects the main external electrode to the apparatus main body; and
a plurality of resistors connected in series in the additional conductor line,
wherein the auxiliary external electrode means includes at least one auxiliary external electrode, which is connected between two adjacent resistors in the additional conductor line.

9. The apparatus according to claim 8 wherein the auxiliary external electrode means includes a plurality of auxiliary external electrodes different in radial distance from the apparatus main body.

10. The apparatus according to claim 9 wherein the material releasing means is a rotary atomizing head for expelling the material radially outward by centrifugal force to operate as a bell-type electrostatic atomizer.

11. The apparatus according to claim 10 wherein the auxiliary external electrodes different in radial distance and the main external electrode are aligned on a parabolic line extending in the same direction as the rotating direction of the rotary atomizing head.
